(19) United States
(12) Patent Application Publication
(10) Pub. No.: US 2016/0209009 A1
(43) Pub. Date: Jul. 21, 2016

(54) QUICK CONNECT PENDANT TO CANOPY AND WIRE

(71) Applicant: Kuzco Lighting, SURREY (CA)

(72) Inventor: Shaokun Yang, Surrey (CA)

(73) Assignee: KUZCO LIGHTING, SURREY (CA)

(21) Appl. No.: 14/725,062

(22) Filed: May 29, 2015

Related U.S. Application Data
(63) Continuation-in-part of application No. 14/601,301, filed on Jan. 21, 2015.

(51) Int. Cl. F21V 21/104; F21V 23/00; F21S 8/04

(52) U.S. Cl. CPC F21V 21/104; F21S 8/043; F21V 23/001; F21Y 2101/02

(57) ABSTRACT

A lighting arrangement can include a canopy, a pendant, a first wire member, a second wire member, and a quick connect assembly. The canopy can be operable to be mounted to a ceiling and can have a first fastener. The pendant can include a light, a supporting cable connected to the light, and a second fastener connected to the supporting cable. The second fastener can be releasibly engageable with the first fastener. The first wire member can extend through the canopy to a first end. The second wire member can be in electrical communication with the light and extend through the supporting cable to a second end. The quick connect assembly can include a first quick connect member attached to the first end and a second quick connect member attached to the second end. The first quick connect member and the second quick connect member can be releasibly engageable with respect to one another and configured to define an electrical pathway between the first wire member and the second wire member when engaged with one another. The first and second wire members can define at least a portion of a wire member assembly configured to transmit one hundred volts and five amps.

### CROSS-REFERENCE TO RELATED APPLICATIONS

This application is a continuation-in-part of U.S. patent application Ser. No. 14/601,301 for a QUICK CONNECT PENDANT TO CANOPY AND WIRE, filed on Jan. 21, 2015 which is hereby incorporated by reference in its entirety.

### BACKGROUND

1. Field

The present disclosure relates generally to lighting arrangements and more specifically to pendant lighting.

2. Description of Related Prior Art

U.S. Pat. No. 7,311,425 discloses a RETROFIT PENDANT LIGHT FIXTURE. The retrofit pendant light fixture is adapted to be hung from a ceiling and readily installed in a socket normally carried within a recessed housing in the ceiling. A lamp is carried on a lower end of an electrical cord extending from an adapter housing.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

A first lighting arrangement can include a canopy, a pendant, a first wire member, a second wire member, and a quick connect assembly. The canopy can be operable to be mounted to a ceiling and can have a first fastener. The pendant can include a light, a supporting cable connected to the light, and a second fastener connected to the supporting cable. The second fastener can be releasibly engageable with the first fastener. The first wire member can extend through the canopy to a first end. The second wire member can be in electrical communication with the light and extend through the supporting cable to a second end. The quick connect assembly can include a first quick connect member attached to the first end and a second quick connect member attached to the second end. The first quick connect member and the second quick connect member can be releasibly engageable with respect to one another and configured to define an electrical pathway between the first wire member and the second wire member when engaged with one another.

A second lighting arrangement can include a canopy, a pendant, and a wire member assembly. The canopy can be operable to be mounted to a ceiling and can have a first fastener. The pendant can include a light with a plurality of light emitting diodes, a supporting cable connected to the light, and a second fastener connected to the supporting cable. The second fastener can be releasibly engageable with the first fastener. The wire member assembly can extend through the canopy and the supporting cable to a light. The wire member assembly can be configured to transmit one hundred volts and five amps.

### BRIEF DESCRIPTION OF THE DRAWINGS

The detailed description set forth below references the following drawings:

FIG. 1 is a perspective view of a lighting arrangement according to an exemplary embodiment of the present disclosure in a disassembled condition;

FIG. 2 is a partial exploded, partial cross-sectional view of an exemplary embodiment of the present disclosure;

FIG. 3 is a perspective view of a quick connect member according to an exemplary embodiment of the present disclosure;

FIG. 4 is a top view of a quick connect member according to an exemplary embodiment of the present disclosure;

FIG. 5 is a side view of the quick connect member shown in FIG. 4;

FIG. 6 is a front view of the quick connect member shown in FIG. 4;

FIG. 7 is a side view of a wire member according to an exemplary embodiment of the present disclosure with various portions partially removed to expose other portions; and

FIG. 8 is a cross-sectional view of the wire member shown in FIG. 7.

### DETAILED DESCRIPTION

The present disclosure, as demonstrated by the exemplary embodiment described below, can provide a quick connect pendant to canopy lighting arrangement. This lighting arrangement allows users to first install a canopy to the ceiling and subsequently install one or more pendants. After the pendant is connected to the canopy, a user can adjust the pendant to a desired length. Embodiments of the present disclosure can be practiced with single pendants and multiple pendants. Further, if a pendant becomes faulty or undesirable, the user can disconnect the pendant from the canopy and install another, different pendant. Most known arrangements require a user to remove the entire lighting arrangement, which is time consuming and costly. Other systems may allow a pendant to be installed after the canopy has been installed onto the ceiling, but none have the capacity for wire adjustment.

Further, embodiments of the present disclosure provide a Solid State Light (hereafter “SSL”) wire member configured to transmit one hundred and twenty volts, five amps. The wire member can include twenty-four Gauge wire. The wire member disclosed herein is small and yet conforms to the UL 758 standard for wiring. The wire member can thus provide a sleeker look and design to the lighting arrangement.

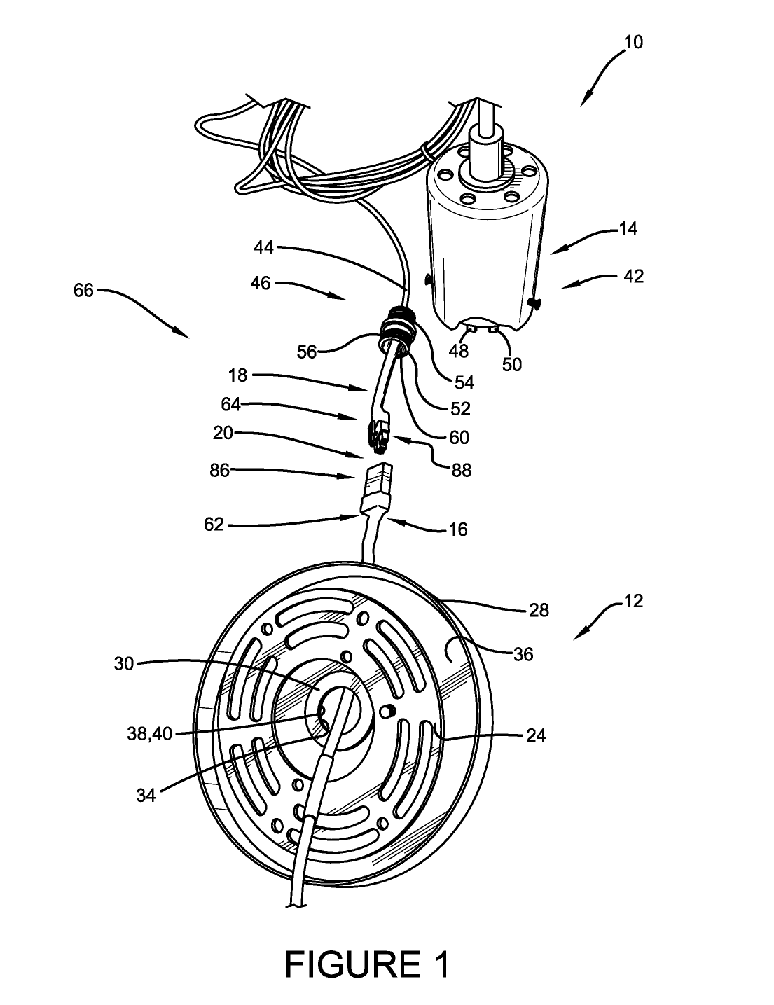

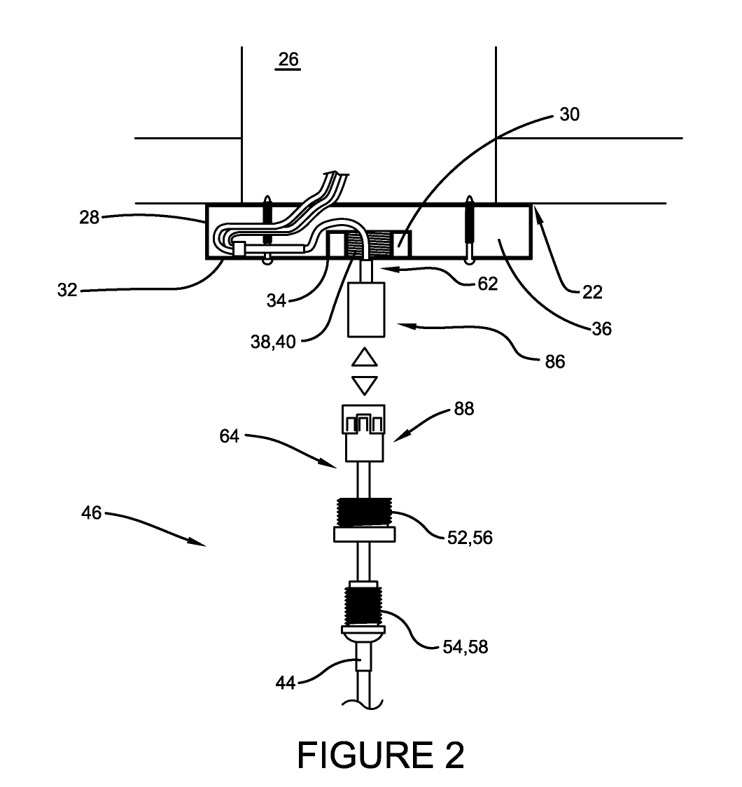

As illustrated in FIG. 1, a lighting arrangement 10 can include a canopy 12, a pendant 14, a first wire member 16, a second wire member 18, and a quick connect assembly 20. The canopy 12 can be operable to be mounted to a ceiling 22 (referenced in FIG. 2). The canopy 12 can be mounted to the ceiling with a plate 24. The plate 24 can be mounted to a junction box 26 (referenced in FIG. 2) in the ceiling 22.

The canopy 12 can also include a shell 28 and a first fastener 30. The shell 28 can include an outer surface 32 with a first aperture 34. The shell 28 can define a cavity 36. The first fastener 30 can be a threaded mounting ring having a second aperture 38. Threads are referenced at 40. The first fastener 30 can be positioned in the cavity 36 such that the second aperture 38 is aligned with the first aperture 34.

The pendant 14 can include a light 42, a supporting cable 44 connected to a push-pin and connected to the light 42, and a second fastener 46 connected to the supporting cable 44. The light 42 can include with a plurality of light emitting diodes, such as light emitting diodes 48, 50. The supporting cable 44 can be connected to the light 12 and mechanically support the light 42 when the light 42 is suspended.

The second fastener 46 can be connected to the supporting cable 44 and releasibly engageable with the first fastener 30. The exemplary second fastener 46 can include a first threaded mounting ring 52 and a second threaded mounting ring 54. The first threaded mounting ring 52 can include external threads 56 configured to engage the threads 40 of the first fastener 30. The first threaded mounting ring 52 can also include internal threads (not visible). The push pin can be inserted into first threaded mounting ring 52 a desired amount to suspend the light 42 at a desired height.

The second threaded mounting ring 54 can include external threads 58 configured to engage the internal threads of the first threaded mounting ring 52. The first threaded mounting ring 52 and the second threaded mounting ring 54 are thus threadingly engageable with one another. Similarly, the second fastener 46 can be releasibly engageable with the first fastener 30 through the threads 40 and 56. The engagement with threads allows the first fastener 30 and the second fastener 46 to be adjustably positioned with respect to one another. Similarly, the engagement with threads allows the first threaded mounting ring 52 and the second threaded mounting ring 54 to be adjustably positioned with respect to one another. As result, the height of the pendant 14 can be varied among a plurality of different positions.

Each of the first threaded mounting ring 52 and the second threaded mounting ring 54 can include an aperture. The internal threads of the first threaded mounting ring 52 can be formed in at least a portion of an aperture 60 of the first threaded mounting ring 52. The aperture of the second threaded mounting ring 54 is not visible in the Figures.

The first wire member 16 can extend through the canopy 12 to a first end 62. The first wire member 16 can be anchored to the interior of the canopy 12, within the cavity 36. The second wire member 18 can be in electrical communication with the light 42 and extend through the supporting cable 44 to a second end 64. The first wire member 16 can pass through the aperture 38 of the first fastener 30. The second wire member 18 can pass through both of the apertures of the first threaded mounting ring 52 and the second threaded mounting ring 54. The first and second wire members 16, 18 can form part of a wire member assembly 66. The connection assembly 20 can bifurcate the wire member assembly 66 into the first wire member 16 and the second wire member 18.

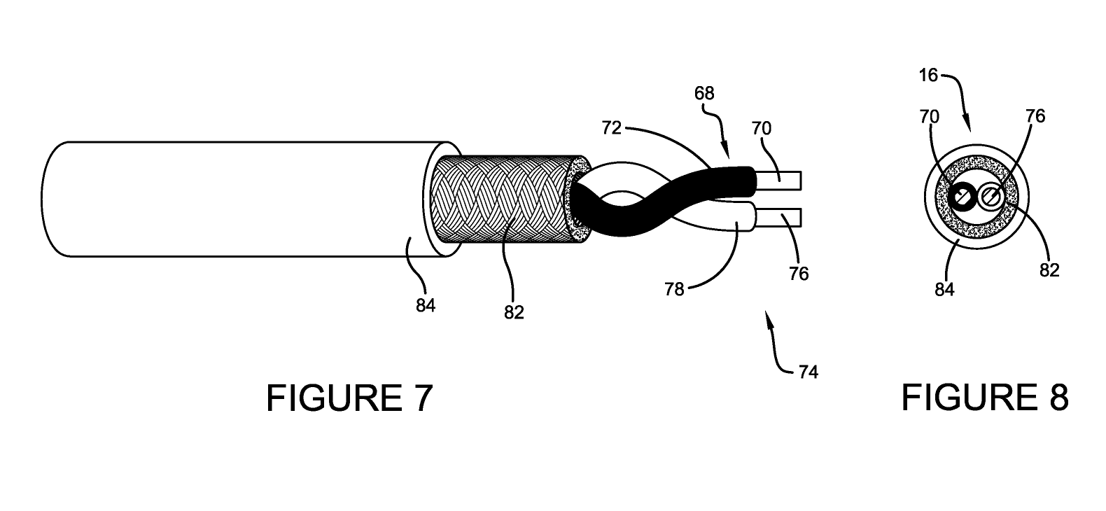

FIGS. 7 and 8 illustrate an exemplary construction of a wire member, in this example the first wire member 16. Both wire members 16 and 18 can be constructed similarly. The first wire member 16 can be configured to transmit one hundred volts and five amps. The first wire member 16 can include a first wire assembly 68 having a first wire 70 enclosed in a first insulating sheath 72. The first wire 70 can be the “hot” wire of the lighting arrangement 10.

The first wire member 16 can also include a second wire assembly 74 having a second wire 76 enclosed in a second insulating sheath 78. The second wire assembly 74 can be the neutral wire of the lighting arrangement 10. The first wire member 16 can also include a ground wire assembly 82 encircling both of the first wire assembly 68 and the second wire assembly 74. The ground wire assembly 82 can be formed from a plurality of strands braided together. Each strand of the braid can be formed from a plurality of individual wires. The first wire member 16 can also include a fourth insulating sheath 84 enclosing the ground wire 82.

The quick connect assembly 20 can include a first quick connect member 86 attached to the first end 62 of the first wire member 16. The quick connect assembly 20 can also include a second quick connect member 88 attached to the second end 64 of the second wire member 18. The first quick connect member 86 and the second quick connect member 88 can be releasibly engageable with respect to one another. The first quick connect member 86 and the second quick connect member 88 can be configured to define an electrical pathway between the first wire member 16 and the second wire member 18 when engaged with one another.

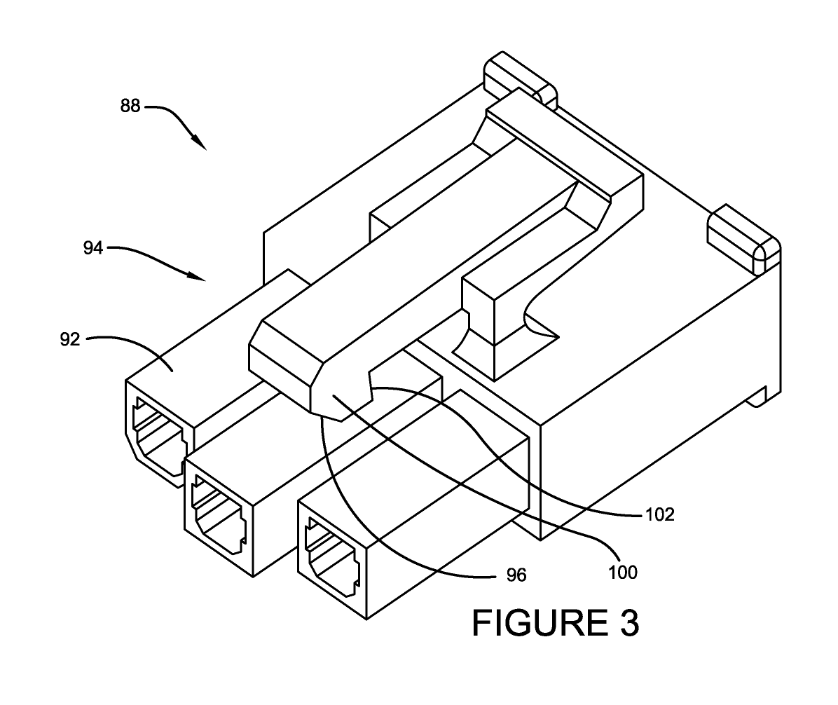

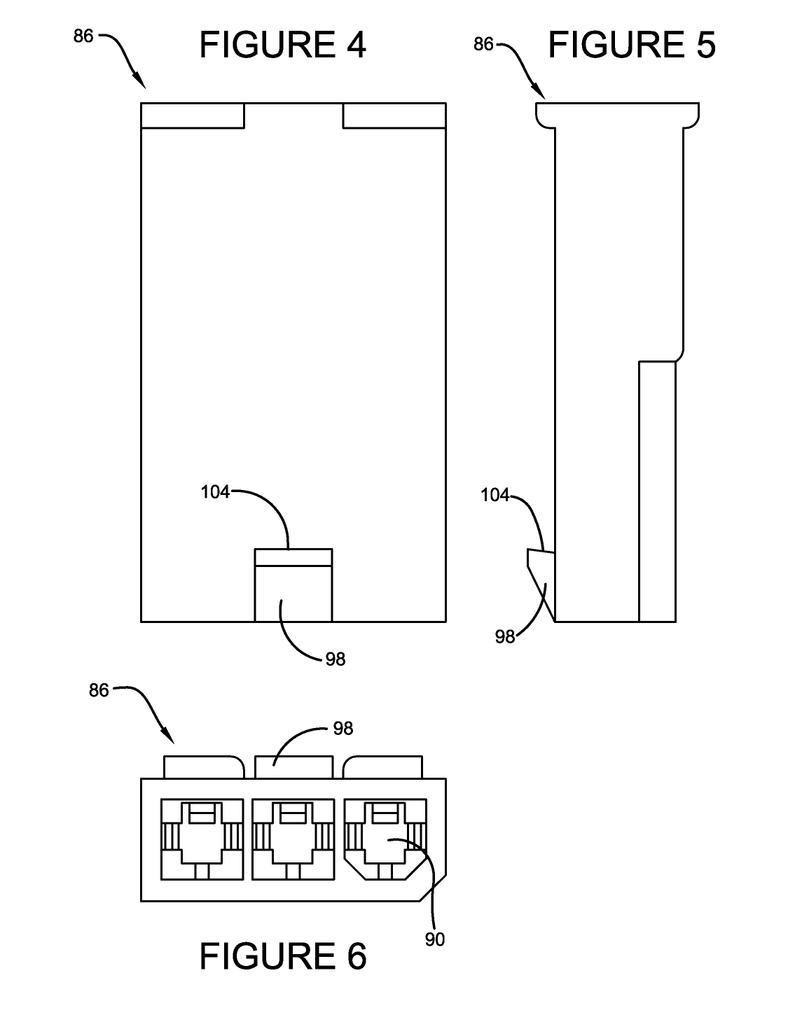

The first quick connect member 86 can include embedded electrical contacts and define three receiving apertures, such as aperture 90 referenced in FIG. 6. The second quick connect member 88 can include embedded electrical contacts and define three engaging projections, such as engaging projection 92 referenced in FIG. 3. The engaging projections can be received in the apertures to complete an electrical connection. The respective electrical contacts in each of the first quick connect member 86 and the second quick connect member 88 can be placed in contact with one another when the engaging projections of the second quick connect member 88 are received in the apertures of the first quick connect member 86.

The first quick connect member 86 and the second quick connect member 88 can be releasibly fixed together through a snap-lock arrangement. The second quick connect member 88 can include a locking arm 94. During insertion of the engaging projections of the second quick connect member 88 in the apertures of the first quick connect member 86, a forward face 96 of the locking arm 94 can ride up a ramp 98 of the first quick connect member 86 and deflect. After a forward portion 100 of the locking arm 94 traverses the ramp 98, the locking arm 94 can snap back and recover, such that a rear face 102 of the forward portion 100 abuts a rear face 104 of the ramp 98. When it is desired to decouple the first quick connect member 86 and the second quick connect member 88, the locking arm 94 can be deflected back and the first quick connect member 86 and the second quick connect member 88 can be pulled apart.

The quick connect assembly 20 is at least partially received in the aperture 38 of the first fastener 30. The quick connect assembly 20 can be sized smaller than the second aperture 38 and can be configured to pass through the second aperture 38 of the first fastener 30. The quick connect assembly 20 can thus be at least partially positionable within the canopy 12. The quick connect assembly 20 can be sized to pass through only the threaded mounting ring 30 in some embodiments. The quick connect assembly 20 can be sized larger than the apertures of the second fastener 46.

In operation, the first wire member 16 can be spliced to electrical wires in the junction box 26. The plate 24 can then be installed to the junction box 26. The first wire member 16 can then be strung through the plate 24, the canopy 12, and the first fastener 30. The canopy 12 can then be mounted on the ceiling 22. The first quick connect member 86 and the second quick connect member 88 can then be coupled and urged into the cavity 36 of the canopy 12. The first threaded mounting ring 52 and the second threaded mounting ring 54 can then be threadingly engaged together. The first threaded mounting ring 52 and the first fastener 30 can then be threadingly engaged together. The height of the pendant 14 can then be adjusted by rotating the first threaded mounting ring 52 relative to the first fastener 30 and/or by rotating the second threaded mounting ring 54 relative to the first threaded mounting ring 52.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A lighting arrangement comprising:
a canopy operable to be mounted to a ceiling and having a first fastener;
a pendant including a light, a supporting cable connected to said light, and a second fastener connected to said supporting cable and releasibly engageable with said first fastener;
a first wire member extending through said canopy to a first end;
a second wire member in electrical communication with said light and extending through said supporting cable to a second end; and
a quick connect assembly including a first quick connect member attached to said first end and a second quick connect member attached to said second end, said first quick connect member and said second quick connect member releasibly engageable with respect to one another and configured to define an electrical pathway between said first wire member and said second wire member when engaged with one another.

2. The lighting arrangement of claim 1 wherein said quick connect assembly is further defined as at least partially positionable within said canopy.

3. The lighting arrangement of claim 1 wherein said canopy further comprises:
a shell having an outer surface with a first aperture and defining a cavity; and
wherein said first fastener is further defined as a threaded mounting ring having a second aperture and positioned in said cavity such that said second aperture is aligned with said first aperture, wherein said quick connect assembly is at least partially received in said second aperture.

4. The lighting arrangement of claim 3 wherein said quick connect assembly is sized smaller than said second aperture and configured to pass through said second aperture.

5. The lighting arrangement of claim 1 wherein said first wire member is anchored to an interior of said canopy.

6. The lighting arrangement of claim 1 wherein said second fastener is further defined as a threaded mounting ring having an aperture.

7. The lighting arrangement of claim 6 wherein said quick connect assembly is sized larger than said aperture.

8. The lighting arrangement of claim 1 wherein:
said first fastener is further defined as a first threaded mounting ring positioned in said canopy; and
said second fastener is further defined as including a second threaded mounting ring having an second aperture, said first threaded mounting ring and said second threaded mounting ring threadingly engageable with one another, wherein said quick connect assembly sized is sized to pass through at least one of said first threaded mounting ring and said second threaded mounting ring.

9. The lighting arrangement of claim 1 wherein said quick connect assembly sized is sized to pass through only one of said first threaded mounting ring and said second threaded mounting ring.

10. The lighting arrangement of claim 1 wherein said first fastener and said second fastener are adjustably positioned with respect to one another.

11. The lighting arrangement of claim 1 wherein said second fastener further comprises:
a first threaded mounting ring; and
a second threaded mounting ring, said second wire member passing through both of said first threaded mounting ring and said second threaded mounting ring, said first threaded mounting ring and said second threaded mounting ring threadingly engageable with one another.

12. The lighting arrangement of claim 1 wherein said light further comprises at least one light emitting diode.

13. The lighting arrangement of claim 12 wherein said light further comprises a plurality of light emitting diodes.

14. The lighting arrangement of claim 13 wherein said first and second wire members are configured to transmit one hundred volts and five amps.

15. A lighting arrangement comprising:
a canopy operable to be mounted to a ceiling and having a first fastener;
a pendant including a light with a plurality of light emitting diodes, a supporting cable connected to said light, and a second fastener connected to said supporting cable and releasibly engageable with said first fastener; and
a wire member assembly extending through said canopy and said supporting cable to a light, wherein said wire member assembly is configured to transmit one hundred volts and five amps.

16. The lighting arrangement of claim 15 wherein said wire member assembly further comprises:
a first wire assembly having a first wire enclosed in a first insulating sheath;
a second wire assembly having a second wire enclosed in a second insulating sheath; and
a ground wire assembly encircling said first wire assembly and said second wire assembly.

17. The lighting arrangement of claim 16 wherein said ground wire assembly is further defined as braided.

18. The lighting arrangement of claim 16 wherein said ground wire assembly is further defined as defining a braid from a plurality of strands and wherein each strand comprises a plurality of wires.

19. The lighting arrangement of claim 18 wherein said wire member assembly further comprises:
a fourth insulating sheath enclosing said ground wire assembly.

20. The lighting arrangement of claim 19 further comprising:
a connection assembly bifurcating said wire member assembly into a first wire member and a second wire member.
